(19) United States
(12) Patent Application Publication
(10) Pub. No.: US 2015/0285502 A1
(43) Pub. Date: Oct. 8, 2015

(54) FUEL NOZZLE SHROUD AND METHOD OF MANUFACTURING THE SHROUD

(71) Applicant: General Electric Company, Schenectady, NY (US)

(72) Inventors: Richard Martin DiCintio, Simpsonville, SC (US); Patrick Benedict Melton, Horse Shoe, NC (US)

(73) Assignee: General Electric Company, Schenectady, NY (US)

(21) Appl. No.: 14/247,523

(22) Filed: Apr. 8, 2014

(51) Int. Cl. F23R 3/28; B22F 5/10; B22F 3/00; B22F 3/105; F02M 53/08; B23K 15/00

(52) U.S. Cl. CPC F23R 3/283; F23R 3/286; F02M 53/08; B23K 15/0086; B22F 3/008; B22F 3/1055; B22F 5/10; B33Y 10/00

(57) ABSTRACT

A fuel nozzle includes a center body that is at least partially surrounded by an outer shroud. The outer shroud is radially spaced from the center body to define a pre-mix flow passage therebetween. The outer shroud includes a main body that defines an inner side portion, an outer side portion and a forward end portion that is axially separated from an aft end portion. The main body further defines a cooling channel that is fully circumscribed between the inner side portion and the outer side portion and that extends at least partially between the forward end portion and the aft end portion. The main body also defines a cooling air inlet that is in fluid communication with the cooling channel and a cooling air outlet that is in fluid communication with the cooling channel downstream from the cooling air inlet.

### FIELD OF THE INVENTION

The present invention generally involves a fuel nozzle cooling scheme. More specifically, the invention relates to a fuel nozzle having cooling channels defined by an outer shroud or burner tube portion of the fuel nozzle and a method for fabricating at least a portion of the fuel nozzle.

### BACKGROUND OF THE INVENTION

Gas turbines are widely used in industrial, marine, aircraft and power generation operations. A gas turbine generally includes a compressor section, a combustion section disposed downstream from the compressor section, and a turbine section disposed downstream from the combustion section.

In order to lower emissions and/or maintain low emissions during operation of the gas turbine, particular combustors include a center or primary fuel nozzle connected to an end cover and multiple secondary fuel nozzles also connected to the end cover and arranged in an annular array around the center fuel nozzle. Each fuel nozzle is in fluid communication with a fuel supply via the end cover fuel and/or a fuel cartridge. As load or demand on the gas turbine changes, fuel flow rate to the various fuel nozzles may be regulated and/or turned on or off to increase or decrease the output of the gas turbine. This configuration typically provides for an enhanced or broadened turndown range wherein the gas turbine can operate at a less than full-speed condition while staying within a predefined emissions production range.

In conventional configurations, a downstream end or outlet of each fuel nozzle terminates at or adjacent to a hot side of a cap or effusion plate. The cap plate extends radially and circumferentially within the combustor substantially adjacent to a combustion chamber defined within the combustor. Typically, the cap plate serves as a thermal shield for the fuel nozzles, particularly the downstream ends of the center and secondary fuel nozzles, thereby reducing thermal stress caused by the proximity of the downstream ends to the combustion flame in the combustion chamber.

In particular combustor designs, the center fuel nozzle includes an outer shroud or burner tube that at least partially defines a premix flow passage for mixing fuel and air prior to introduction into the combustion chamber. It has been shown that the turndown range may be enhanced or broadened by extending the outer shroud or burner tube axially downstream from the hot side of the cap plate towards the combustion chamber. One challenge has been to sufficiently cool the downstream end of the outer shroud. Therefore, an improved fuel nozzle would be useful.

### BRIEF DESCRIPTION OF THE INVENTION

Aspects and advantages of the invention are set forth below in the following description, or may be obvious from the description, or may be learned through practice of the invention.

One embodiment of the present invention is a fuel nozzle. The fuel nozzle includes a center body and an outer shroud that is radially spaced from the center body, thus defining a pre-mix flow passage therebetween. The outer shroud includes a main body that defines an inner side portion, an outer side portion and a forward end portion that is axially separated from an aft end portion. The main body defines a cooling channel that is fully circumscribed between the inner side portion and the outer side portion and that extends at least partially between the forward end portion and the aft end portion. The main body further defines at least one cooling air inlet that is in fluid communication with the cooling channel and at least one cooling air outlet that is in fluid communication with the cooling channel downstream from the cooling air inlet.

Another embodiment of the present disclosure is combustor. The combustor includes an outer casing and a primary fuel nozzle having a center body that extends axially downstream from the end cover within the outer casing. The primary fuel nozzle further includes an outer shroud that is coaxially aligned with the center body and that is radially spaced from the center body to define a pre-mix flow passage therebetween. At least one secondary fuel nozzle extends within the casing substantially parallel to the primary fuel nozzle. The secondary fuel nozzle terminates at an outlet end. The outer shroud includes an annular main body that defines an inner side portion, an outer side portion and a forward end portion axially separated from an aft end portion where the aft end portion extends axially beyond the outlet end of the secondary fuel nozzle. The main body further defines a cooling channel that is fully circumscribed within the main body, a cooling air inlet that is in fluid communication with the cooling channel and a cooling air outlet that is in fluid communication with the cooling channel downstream from the cooling air inlet.

The present invention also includes a gas turbine. The gas turbine includes a compressor, a combustor disposed downstream from the compressor and a turbine that is disposed downstream from the combustor. The combustor includes end cover that is coupled to an outer casing and a fuel nozzle. The fuel nozzle includes a center body that extends axially downstream from the end cover within the outer casing and an outer shroud that is coaxially aligned with the center body. The outer shroud is radially spaced from the center body to define a pre-mix flow passage therebetween. The outer shroud includes an annular main body that defines an inner side portion, an outer side portion and a forward end portion that is axially separated from an aft end portion. The aft end portion is disposed proximate to a combustion zone defined within the combustor. The main body further defines a cooling channel that is fully circumscribed within the main body, a cooling air inlet in fluid communication with the cooling channel and a cooling air outlet in fluid communication with the cooling channel downstream from the cooling air inlet.

Another embodiment of the present invention includes a method for fabricating a main body of an outer shroud portion of a fuel nozzle where the main body defines a cooling channel fully circumscribed within the main body. The method comprises the steps of determining three-dimensional information of the main body including the cooling channel, converting the three-dimensional information into a plurality of slices that define a cross-sectional layer of the main body where a void is defined within at least some of the layers thus defining the cooling channel. The method further includes successively forming each layer of the main body by fusing a metallic powder using a least one of laser energy or electron beam energy.

One embodiment of the present invention includes a fuel nozzle. The fuel nozzle includes an outer shroud having an annularly shaped main body and a cooling channel that is fully circumscribed within the main body where the main body is made using an additive manufacturing process.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a functional block diagram of an exemplary gas turbine that may incorporate various embodiments of the present invention;

FIG. 2 is a cross-sectional side view of a portion of an exemplary can type combustor as may be incorporated in the present invention;

FIG. 3 is an upstream view of a portion of the combustor as shown in FIG. 2, including an exemplary primary fuel nozzle and a plurality of exemplary secondary fuel nozzles according to one or more embodiments of the present invention;

FIG. 4 is an enlarged cross sectional side view of an exemplary primary fuel nozzle according to at least one embodiment of the present invention;

FIG. 5 is an upstream view of the primary fuel nozzle as shown in FIG. 4, according to one embodiment of the present invention;

FIG. 6 is a cross sectional view of an exemplary cooling channel including various flow features according to one or more embodiments of the present invention;

FIG. 7 is a partial perspective view of an outer shroud portion of the primary fuel nozzle including multiple cooling channels according to various embodiments of the present invention;

FIG. 8 is a partial perspective view of an outer shroud portion of the primary fuel nozzle including multiple cooling channels according to various embodiments of the present invention;

FIG. 9 is a cross sectional side view of a portion of a combustor including the primary fuel nozzle as shown in FIG. 4, according to one or more embodiments of the present invention;

FIG. 10 is a cross sectional side view of a portion of a combustor including an exemplary embodiment of the primary fuel nozzle, according to one or more embodiments of the present invention; and

FIG. 11 is a flow chart illustrating an exemplary embodiment of a method for fabricating a main body portion of an outer shroud of a fuel nozzle as shown in various embodiments in FIGS. 4-10.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents. Although exemplary embodiments of the present invention will be described generally in the context of fuel nozzle for a land based power generating gas turbine combustor for purposes of illustration, one of ordinary skill in the art will readily appreciate that embodiments of the present invention may be applied to any combustor for any type of gas turbine such as a marine or aircraft gas turbine and are not limited to combustors or combustion systems for land based power generating gas turbines unless specifically recited in the claims.

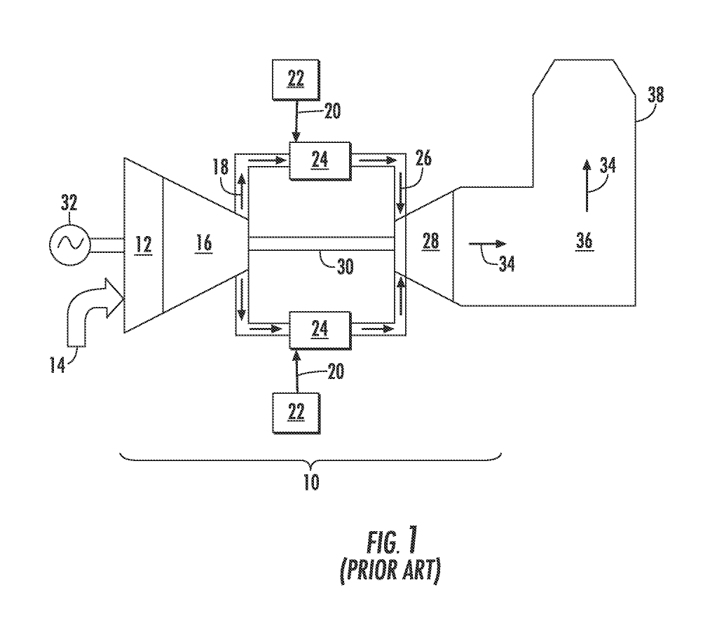

Referring now to the drawings, wherein identical numerals indicate the same elements throughout the figures, FIG. 1 provides a functional block diagram of an exemplary gas turbine 10 that may incorporate various embodiments of the present invention. As shown, the gas turbine 10 generally includes an inlet section 12 that may include a series of filters, cooling coils, moisture separators, and/or other devices to purify and otherwise condition a working fluid (e.g., air) 14 entering the gas turbine 10. The working fluid 14 flows to a compressor section where a compressor 16 progressively imparts kinetic energy to the working fluid 14 to produce a compressed working fluid 18.

The compressed working fluid 18 is mixed with a fuel 20 from a fuel supply system 22 to form a combustible mixture within one or more combustors 24. The combustible mixture is burned to produce combustion gases 26 having a high temperature, pressure and velocity. The combustion gases 26 flow through a turbine 28 of a turbine section to produce work. For example, the turbine 28 may be connected to a shaft 30 so that rotation of the turbine 28 drives the compressor 16 to produce the compressed working fluid 18. Alternately or in addition, the shaft 30 may connect the turbine 28 to a generator 32 for producing electricity. Exhaust gases 34 from the turbine 28 flow through an exhaust section 36 that connects the turbine 28 to an exhaust stack 38 downstream from the turbine 28. The exhaust section 36 may include, for example, a heat recovery steam generator (not shown) for cleaning and extracting additional heat from the exhaust gases 34 prior to release to the environment.

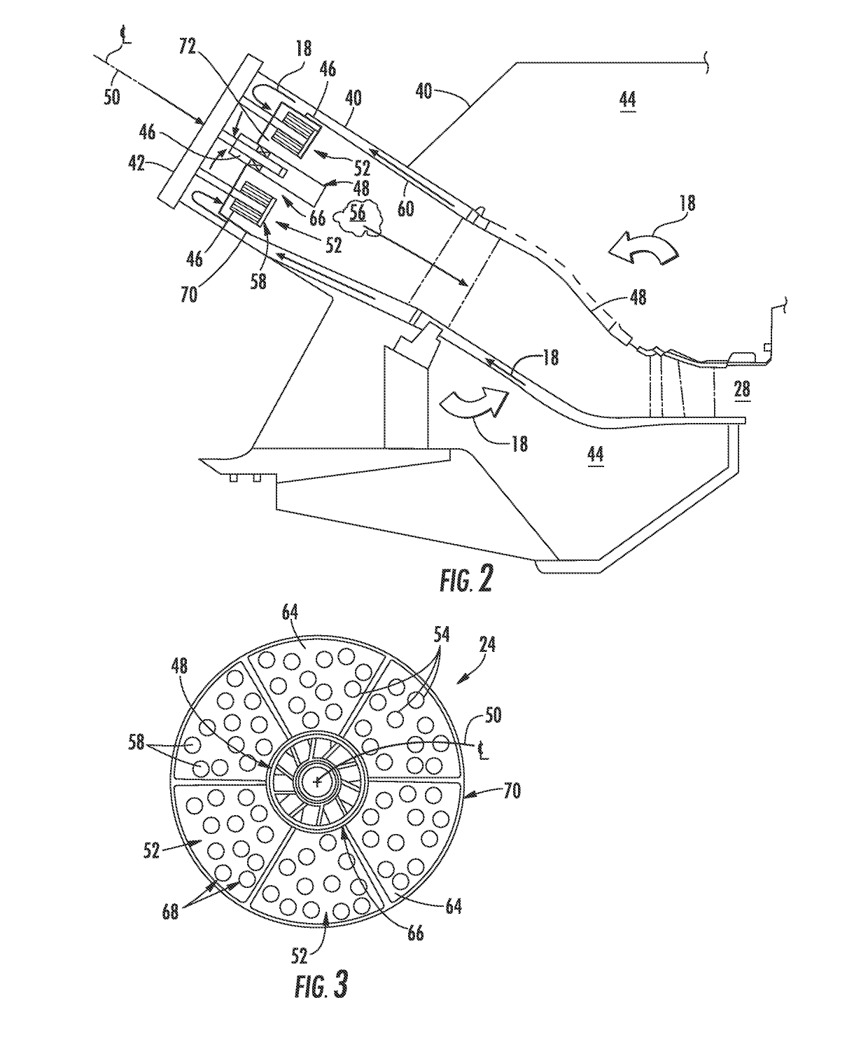

The combustor 24 may be any type of combustor known in the art, and the present invention is not limited to any particular combustor design unless specifically recited in the claims. For example, the combustor 24 may be a can type or a can-annular type of combustor. FIG. 2 provides a cross-section side view of a portion of an exemplary can type combustor 24. As shown in FIG. 2, an outer casing 40 surrounds at least a portion of the combustor 24. An end cover 42 is coupled to the outer casing 40 at one end of the combustor 24. The end cover 42 and the outer casing 40 generally define a high pressure plenum 44 which at least partially surrounds the combustor 24. In operation, the high pressure plenum 44 receives the compressed working fluid 18 from the compressor 16.

In particular embodiments, the combustor 24 includes one or more fuel nozzles 46. In one embodiment, the combustor includes a primary fuel nozzle 48 that extends substantially axially within the combustor 24 with respect to axial centerline 50. For example, in one configuration, the primary fuel nozzle 48 extends downstream from an inner surface of the end cover 42. FIG. 3 is an upstream view of a portion of the combustor 24 including the primary fuel nozzle 48 and a plurality of exemplary secondary fuel nozzles 52 according to one or more embodiments of the present invention. In various embodiments, as shown in FIGS. 2 and 3, a plurality of secondary fuel nozzles 52 are annularly arranged around the primary fuel nozzle 48. In one embodiment, as shown in FIG. 2, the secondary fuel nozzles 52 extend substantially parallel to the primary fuel nozzle 48 within the combustor 24.

As shown in FIGS. 2 and 3, the secondary fuel nozzles 52 may include bundled tube type fuel nozzles having a plurality of tubes 54 for providing a fuel and air mixture to a combustion zone 56 (FIG. 2) that is defined within the combustor 24. In other embodiments, the secondary fuel nozzles 52 may include conventional pre-mixer type fuel nozzles (not shown) which may be partially configured similarly to the primary fuel nozzle 50. However, the secondary nozzles 52 are not limited to either bundled tube or conventional pre-mix type fuel nozzles unless specifically recited in the claims. Each of the secondary fuel nozzles 52 and/or the tubes 54 terminate at an outlet end 58 which provides for fluid communication between the secondary fuel nozzles 52 and the combustion zone 56.

As shown in FIG. 2, the combustion zone 56 may be at least partially defined within an annularly shaped liner 60 that extends downstream from the primary and the secondary fuel nozzles 48, 52 towards an inlet to the turbine 28. The liner 60 at least partially defines a hot gas path 62 for routing the combustion gases 26 through the combustor 24.

As shown in FIGS. 2 and 3, a cap or effusion plate 64 extends radially and circumferentially within the combustor 24 downstream from the end cover 42 (FIG. 2). The cap plate 64 may comprise a single continuous plate or may be divided in to arcuate or other shaped sections (FIG. 3). The cap plate 64 may at least partially define a primary fuel nozzle passage 66. The cap plate 64 may also define a plurality of secondary fuel nozzle passages 68. For example, as shown in FIG. 3, the cap plate 64 may define a corresponding secondary fuel nozzle passage 68 for each of the tubes 54 of a bundled tube type fuel nozzle.

The outlet end 58 of each of the secondary fuel nozzles 52 and/or the tubes 54 terminates generally at, proximate to or adjacent to the cap plate 64 so as to provide for fluid communication through the cap plate 64 and into the combustion zone 56. The cap plate 64 is connected to an end portion of an outer sleeve 70. The cap plate 64 and the outer sleeve 70 may be components of a cap assembly. In particular embodiments, the cap plate 64 and/or the outer sleeve 70 may at least partially define a cooling air plenum 72 (FIG. 2) within the combustor 24. The cooling air plenum 72 may be in fluid communication with the high pressure plenum 44 (FIG. 2) and/or another cooling air or cooling medium source (not shown).

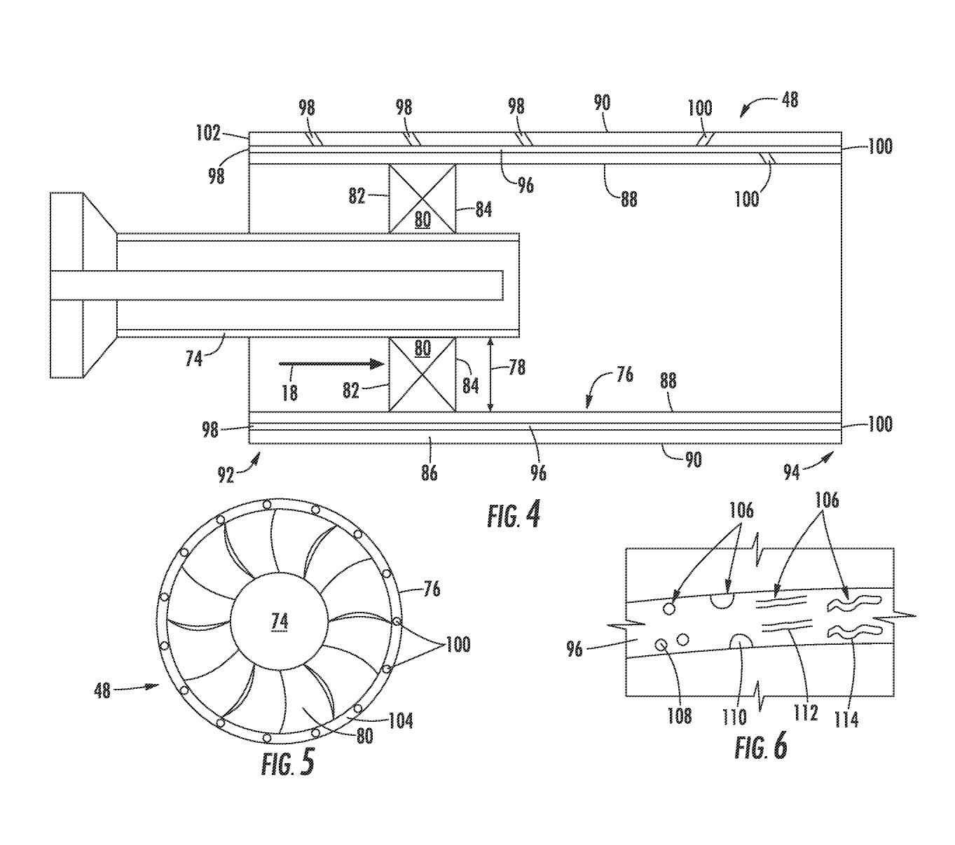

FIG. 4 provides an enlarged cross sectional side view of an exemplary primary fuel nozzle 48 according to at least one embodiment of the present invention. In one embodiment, as shown in FIG. 4, the primary fuel nozzle 48 includes a center body 74, an outer shroud 76 that is radially spaced from the center body 74 and a pre-mix flow passage 78 that is at least partially defined between the center body 74 and the outer shroud 76. The center body 74 may be configured to mount to the end cover 42 via a flange and bolt or other connection. The center body 74 may be fluidly connected to the end cover 42 (FIG. 2) and/or to a fuel supply. In particular embodiments, as shown in FIG. 4, the center body 74 may be configured to receive a fuel and/or diluent cartridge.

In one embodiment, as shown in FIG. 4, the primary fuel nozzle 48 includes a plurality of turning or swirler vanes 80 that extend between the center body 74 and the outer shroud 76 within the pre-mix flow passage 78. As shown in FIG. 4, the turning vanes 80 generally include a leading edge portion 82 and a trailing edge portion 84. The leading edge portion 82 generally faces towards a flow of the compressed working fluid 18.

As shown in FIG. 4, the outer shroud 76 comprises an annularly shaped main body 86 having an inner side 88 portion, outer side portion 90 and a forward end portion 92 that is axially separated from an aft end portion 94. In at least one embodiment, the main body 86 defines at least one cooling channel 96. The cooling channel 96 is fully circumscribed between the inner side portion 88 and the outer side portion 90. The cooling channel 96 extends at least partially between the forward end portion 92 and the aft end portion 94 of the main body 86. In particular embodiments, the main body 86 defines a plurality of cooling channels 96. The annularly shaped main body 86 is made as a single piece during manufacturing. Thus, the main body 86 has a monolithic construction, and is different from a component that has been made from a plurality of component pieces that have been joined together via brazing or other joining process to form a single component.

In particular embodiments, the main body 86 including the cooling channel 96 or cooling channels 96 may be formed by additive manufacturing methods or processes. As used herein, the terms “additively manufactured” or “additive manufacturing techniques or processes” include but are not limited to various known 3D printing manufacturing methods such as Extrusion Deposition, Wire, Granular Materials Binding, Powder Bed and Inkjet Head 3D Printing, Lamination and Photo-polymerization.

The main body 86 further defines at least one cooling air inlet 98 that is in fluid communication with the cooling channel 96 and a cooling air outlet 100 that is in fluid communication with the cooling channel 96 downstream from the cooling air inlet 98. The cooling air inlet 98 may be defined or disposed along any wall, side or portion of the main body 86. For example, in various embodiments, as shown in FIG. 4, the cooling air inlet 98 is defined proximate to the forward end portion 92 of the main body 86. In one embodiment, the cooling air inlet 98 is disposed or defined within a forward wall 102 of the main body 86, thus providing for fluid communication through the forward wall 102 and into the cooling channel 96. In one embodiment, the cooling air inlet 98 provides for fluid communication through the outer side portion 90 of the main body 86 into the cooling channel 96.

In one embodiment, the cooling air inlet 98 is defined along the outer side portion 90 upstream from the swirler vanes 80. In one embodiment, the cooling air inlet 98 is defined along the outer side portion 90 downstream from the swirler vanes 80 between the trailing edges 84 of the turning vanes 80 and the aft end portion 94 of the main body 86. In one embodiment, the cooling air inlet 98 is defined or disposed between the leading edge portion 82 and the trailing edge portion 84 of the swirler vanes 80. In particular embodiments, a plurality of cooling air inlets 98 are defined or disposed along one or more of the forward wall 102 and the outer side portion 90 of the main body 86.

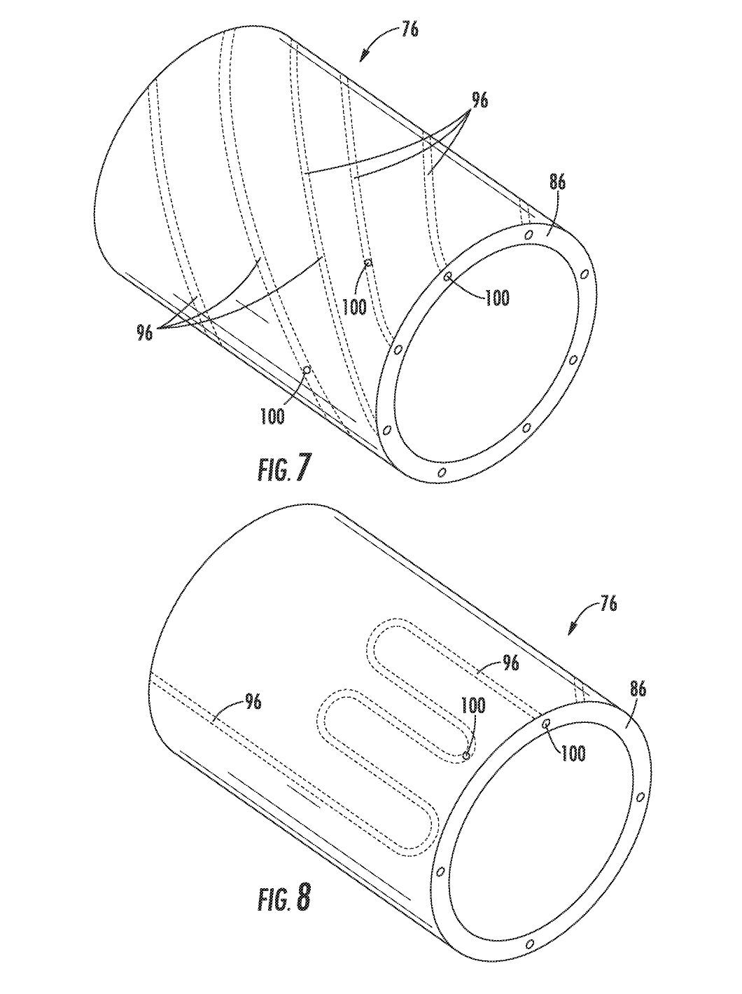

FIG. 5 is an upstream view of the primary fuel nozzle 48 as shown in FIG. 4, according to one embodiment of the present invention. The cooling air outlet 100 or cooling air outlets 100 may be defined or disposed anywhere along the main body 86. For example, in one embodiment, as shown in FIGS. 4 and 5, the aft end portion 94 of the main body 86 terminates at an aft wall 104 that extends between the inner and outer side portions 88, 90 and the cooling air outlet 100 or at least some of the cooling air outlets 100 are defined or disposed on the aft wall 106, thus providing for fluid communication from the cooling channel 96 through the aft wall 106. In various embodiments, as shown in FIG. 4, the cooling air outlet 100 or at least some of the cooling air outlets 100 may be defined or disposed on the outer side portion 90 of the main body 86. In addition or in the alternative, the cooling air outlet 100 or at least some of the cooling air outlets 100 may be defined or disposed on the inner side portion 88 of the main body 86, thus providing for fluid communication from the cooling channel 96 through the inner wall 88 into the premix flow passage 78 upstream from the aft wall 106.

FIG. 6 provides a cross sectional view of an exemplary cooling channel 96 according to one or more embodiments of the present invention. As shown in FIG. 6, one or more flow features 106 may be defined within the cooling channel 96. The flow feature or features 106 may include concave of convex dimples 108, ribs 110, slots 112, grooves 114 or other features for enhancing cooling effectiveness of the compressed working fluid 18 as it flows through the corresponding cooling channel 96. In various embodiments, the flow feature 106 or features are formed via one or more additive manufacturing methods, techniques or processes previously discussed, thus providing for greater accuracy and/or more intricate details within the cooling channel 96 than previously producible by conventional manufacturing processes.

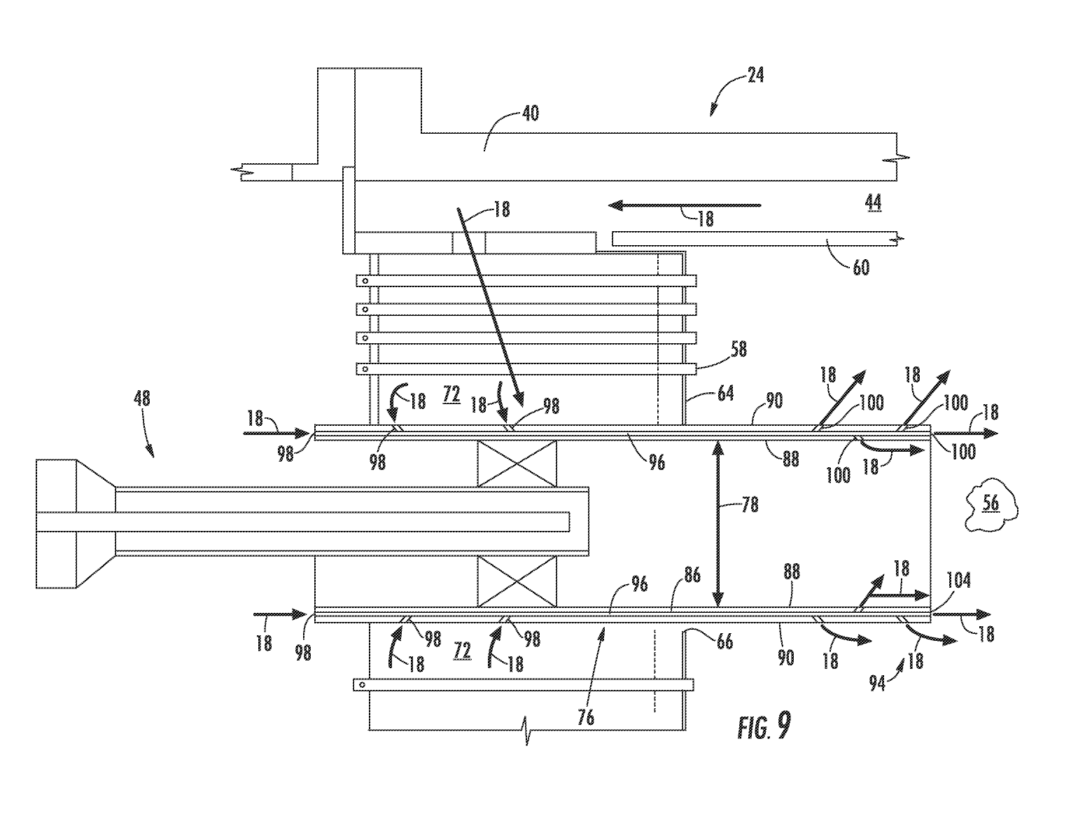

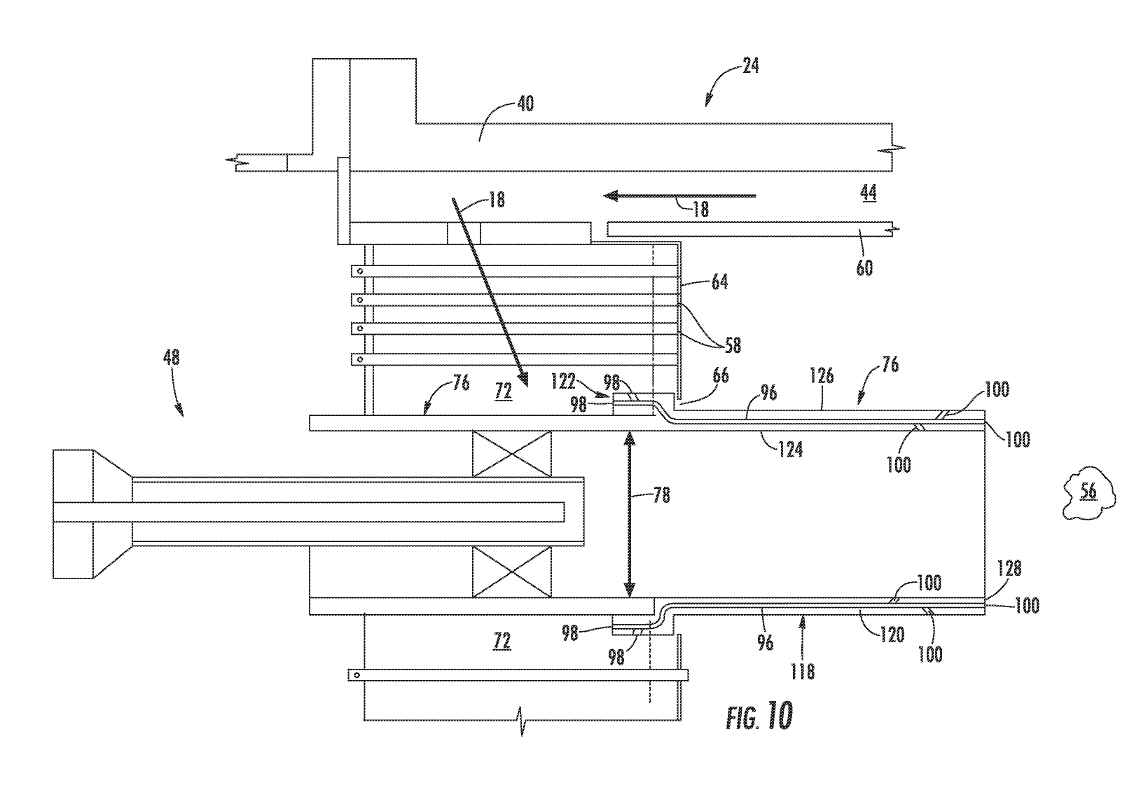

FIGS. 7 and 8 are partial perspective views of the outer shroud 76 according to various embodiments of the present invention. As shown in FIG. 4, at least a portion of the cooling channel 96 or cooling channels 96 extend substantially axially within the main body 86. In one embodiment, as shown in FIG. 7, the cooling channel 96 or at least some of the cooling channels 96 extend within the main body 86 in a substantially helical or circumferential pattern, thus increasing the length of the cooling channel 96 through the main body 86. In one embodiment, the cooling channel 96 or cooling channels 96 extend at least partially around the aft end portion 94.

In one embodiment, as shown in FIG. 8, the cooling channel 96 or at least some of the cooling channels 96 extend within the main body 86 in a substantially serpentine or winding pattern, thus increasing the length of the cooling channel 96 through the main body 86. The serpentine or winding and/or the helical and circumferential patterns increase residence or flow time of the compressed working fluid 18 as it flows through the cooling channel 96 or cooling channels 96 defined by the main body 86, thus increasing the cooling efficiency of the compressed working fluid 18 and reducing thermal stress on the outer shroud 76. The cooling channel 96 or cooling channels may extend in multiple patterns within the main body 86 of the outer shroud 76 and are not limited to any single or particular pattern unless specifically recited in the claims.

FIG. 9 is a cross sectional side view of a portion of the combustor 24 including the primary fuel nozzle 48 according to one or more embodiments of the present invention. As shown in FIG. 9, the outer shroud 76 extends through the primary fuel nozzle passage 66 defined within the cap plate 64. As shown, the aft end portion 94 extends axially beyond the outlet end 58 of the secondary fuel nozzle 52 towards the combustion zone 56 such that the aft end portion 94 is positioned closer to the combustion zone 56 than the outlet ends 58 of the secondary fuel nozzles 52. As shown, the cooling air inlet 98 or at least some of the cooling air inlets 98 may be in fluid communication with the cooling air plenum 72.

In operation, as shown in the various embodiments illustrated in FIGS. 2-9, a portion of the compressed working fluid 18 is routed into the cooling channel 96 via one or more of the cooling air inlets 98. In one embodiment, the compressed working fluid 18 may be routed into the cooling air plenum 72 from the high pressure plenum 44 and then into the cooling air inlet 98 or cooling air inlets 98. The compressed working fluid 18 then flows through the cooling channel 96 or cooling channels 96 thus providing at least one of convective and impingement cooling to the inner side portion 88 and/or the outer side portion 90 of the main body 86 particularly at or proximate to the aft end portion 94 of the outer shroud 76.

As previously described the serpentine, circumferential, axial and/or the helical patterns of the cooling channel 96 or cooling channels 96 increase the residence or flow time of the compressed working fluid 18 within the cooling channel 96 or cooling channels 96, thus enhancing the overall cooling effectiveness of the compressed working fluid 18. In particular embodiments, the flow feature 106 or flow features 106 may further enhance the cooling effectiveness of the compressed working fluid 18, thereby improving overall mechanical performance of the primary fuel nozzle 48.

The compressed working fluid 18 exits the cooling channel 96 or cooling channels 96 through the cooling air outlet 100 or cooling air outlets 100. When exiting through the aft wall 104, the compressed working fluid 18 may flow into the combustion zone 56. When the compressed working fluid 18 exits through the cooling air outlet 100 or cooling air outlets 100 disposed on the inner side portion 88, the compressed working fluid 18 may provide film cooling of the inner side portion 88. When the compressed working fluid 18 exits through the cooling air outlet 100 or cooling air outlets 100 disposed on the outer side portion 90, the compressed working fluid 18 may provide film cooling of the outer side portion 90.

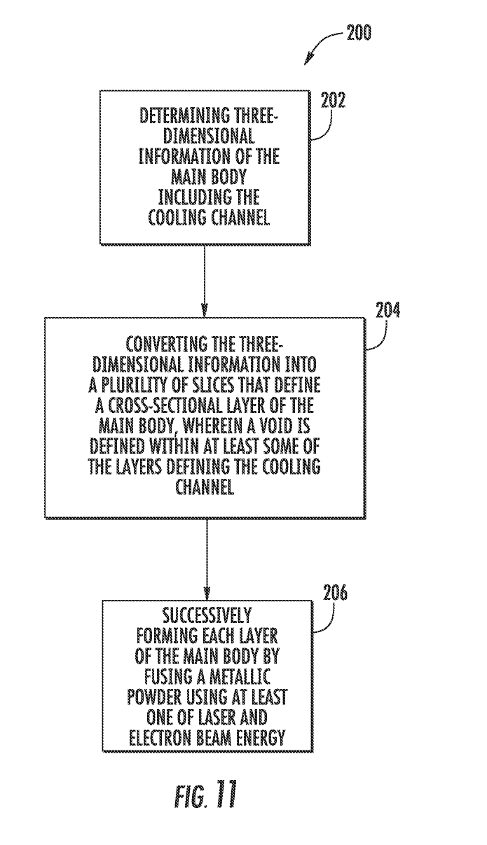

FIG. 10 is a cross sectional side view of a portion of the combustor 24 including an exemplary embodiment of the primary fuel nozzle 48 according to one or more embodiments of the present invention. As shown in FIG. 10, the outer shroud 76 may comprise a forward sleeve portion 116 and a coaxially aligned burner tube or extension tube portion 118 that extends axially downstream from the forward sleeve portion 116. The forward sleeve portion 116 and the burner tube portion 118 define the premix flow passage 78. The burner tube portion 118 includes a main body 120. The main body 120 of the burner tube portion 118 defines the cooling channels 96 as previously described and illustrated.

The cooling channel 96 or channels 96 are fully inscribed within the main body 120. The main body 120 of the burner tube portion 118 further defines the cooling air inlet 98 or cooling air inlets 98 at or proximate to an upstream end 122 of the burner tube portion 118. In addition, the main body 120 further defines the cooling air outlet 100 or cooling air outlets 100 along at least one of an inner side portion 124, an outer side portion 126 or an aft wall 128 of the main body 120. As shown in FIG. 10, the burner tube portion 118 extends through the primary fuel nozzle passage 66. The cooling channel inlets 98 may be in fluid communication with the cooling air plenum 72.

As previously stated, the annularly shaped main body 86 of the outer shroud 76 can be made using an additive manufacturing process. In one embodiment, the additive manufacturing process of Direct Metal Laser Sintering DMLS is a preferred method of manufacturing the annularly shaped main body 86 described herein.

FIG. 11 is a flow chart illustrating an exemplary embodiment of a method 200 for fabricating the annularly shaped main body 86 as described herein and as shown in FIGS. 4-10. Method 200 includes fabricating at least the annularly shaped main body 86 using the Direct Metal Laser Sintering (DMLS) process.

DMLS is a known manufacturing process that fabricates metal components using three-dimensional information, for example a three-dimensional computer model of the component. The three-dimensional information is converted into a plurality of slices where each slice defines a cross section of the component for a predetermined height of the slice. The component is then “built-up” slice by slice, or layer by layer, until finished. Each layer of the component is formed by fusing a metallic powder using a laser.

Accordingly, method 200 includes the step 202 of determining three-dimensional information of the annularly shaped main body 86 and the step 204 of converting the three-dimensional information into a plurality of slices where each slice defines a cross-sectional layer of the annularly shaped main body 86. The annularly shaped main body 86 is then fabricated using DMLS, or more specifically each layer is successively formed 206 by fusing a metallic powder using laser energy. Each layer has a size between about 0.0005 inches and about 0.001 inches. As a result, the cooling channel 96 or cooling channels 96 may be defined fully circumscribed within the main body 86. In addition, cooling channel 96 or cooling channels 96 may be formed and/or the cooling features 106 may be formed in intricate previously non-producible patterns and/or shapes.

The annularly shaped main body 86 may be fabricated using any suitable laser sintering machine. Examples of suitable laser sintering machines include, but are not limited to, an EOSINT® M 270 DMLS machine, a PHENIX PM250 machine, and/or an EOSINT® M 250 Xtended DMLS machine, available from EOS of North America, Inc. of Novi, Mich. The metallic powder used to fabricate the annularly shaped main body 86 is preferably a powder including cobalt chromium, but may be any other suitable metallic powder, such as, but not limited to, HS 1888 and INC0625. The metallic powder can have a particle size of between about 10 microns and 74 microns, preferably between about 15 microns and about 30 microns.

Although the methods of manufacturing the annularly shaped main body 86 including the cooling channel 96 or cooling channels 96 and the cooling features have been described herein using DMLS as the preferred method, those skilled in the art of manufacturing will recognize that any other suitable rapid manufacturing methods using layer-by-layer construction or additive fabrication can also be used. These alternative rapid manufacturing methods include, but not limited to, Selective Laser Sintering (SLS), 3D printing, such as by inkjets and laserjets, Sterolithography (SLS), Direct Selective Laser Sintering (DSLS), Electron Beam Sintering (EBS), Electron Beam Melting (EBM), Laser Engineered Net Shaping (LENS), Laser Net Shape Manufacturing (LNSM) and Direct Metal Deposition (DMD).

The various embodiments provided herein, provide various technical advantages over existing fuel nozzles and/or combustors. For example, the cooling channel 96 or cooling channels 96 fully inscribed within and defined by the main body 86 allow for a deeper penetration of the pre-mixed fuel and air mixture into the combustion zone 56 during various operational modes of combustor, thus increasing operational flexibility while enhancing the mechanical life of the primary fuel nozzle 48. In addition or in the alternative, manufacturing the main body 86 via the additive manufacturing process allows for more intricate and/or complex cooling channel patterns than were producible by existing manufacturing methods. In addition, the additively manufactured main body 86 reduces potential leakage and other potential undesirable effects of having multiple components brazed or otherwise joined together to form the cooling channel 96.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A fuel nozzle, comprising:
a center body;
an outer shroud radially spaced from the center body to define a pre-mix flow passage therebetween, the outer shroud comprising an annular main body having an inner side portion, an outer side portion and a forward end portion axially separated from an aft end portion; and
wherein the main body defines a cooling channel fully circumscribed between the inner side portion and the outer side portion and extending at least partially between the forward end portion and the aft end portion, the main body further defining a cooling air inlet in fluid communication with the cooling channel and a cooling air outlet in fluid communication with the cooling channel downstream from the cooling air inlet.

2. The fuel nozzle as in claim 1, wherein at least a portion of the cooling channel extends within the main body in at least one of a serpentine pattern and a helical pattern.

3. The fuel nozzle as in claim 1, wherein at least a portion of the cooling channel extends substantially axially within the main body.

4. The fuel nozzle as in claim 1, wherein the main body defines one or more flow features disposed along the cooling channel.

5. The fuel nozzle as in claim 1, wherein at least a portion of the cooling channel extends within the main body at least partially around the aft end portion.

6. The fuel nozzle as in claim 1, wherein the cooling air inlet provides for fluid communication into the cooling channel through at least one of the outer side portion of the main body and a forward end portion of the main body.

7. The fuel nozzle as in claim 1, further comprising a plurality of turning vanes that extend radially outwardly from the center body upstream from the aft end portion of the main body, each of the turning vanes having a leading edge and a trailing edge, wherein the cooling air inlet is disposed along the outer side portion at a point between the trailing edges of the turning vanes and the aft end portion of the main body.

8. The fuel nozzle as in claim 1, wherein the cooling air outlet provides for fluid communication from the cooling channel through the inner wall portion into the premix passage.

9. The fuel nozzle as in claim 1, wherein the aft end portion of the main body terminates at an aft wall, wherein the cooling air outlet provides for fluid communication from the cooling channel through the aft wall.

10. A combustor, comprising:
an outer casing;
a primary fuel nozzle having a center body that extends axially within the outer casing and an outer shroud coaxially aligned with the center body, wherein the outer shroud is radially spaced from the center body to define a pre-mix flow passage therebetween;
at least one secondary fuel nozzle that extends substantially parallel to the primary fuel nozzle, the secondary fuel nozzle terminating at an outlet end;
wherein the outer shroud includes an annular main body defining an inner side portion, an outer side portion and a forward end portion axially separated from an aft end portion, the aft end portion extending axially beyond the outlet end of the secondary fuel nozzle; and
wherein the main body further defines a cooling channel fully circumscribed within the main body, a cooling air inlet in fluid communication with the cooling channel and a cooling air outlet in fluid communication with the cooling channel downstream from the cooling air inlet.

11. The combustor as in claim 10, wherein at least a portion of the cooling channel extends within the main body in at least one of a serpentine pattern and a helical pattern.

12. The combustor as in claim 10, wherein at least a portion of the cooling channel extends within the main body at least partially around the aft end portion.

13. The combustor as in claim 10, wherein the cooling air inlet provides for fluid communication into the cooling channel through at least one of the outer side portion of the main body and a forward end portion of the main body.

14. The combustor as in claim 10, further comprising a plurality of turning vanes that extend radially outwardly from the center body upstream from the aft end portion of the main body, each of the turning vanes having a leading edge and a trailing edge, wherein the cooling air inlet is disposed along the outer side portion at a point between the trailing edges of the turning vanes and the aft end portion of the main body.

15. The combustor as in claim 10, wherein the aft end portion of the main body terminates at an aft wall that extends between the inner and outer side portions, wherein the cooling air outlet provides for fluid communication from the cooling channel through at least one of the aft wall radially outwardly from the premix passage and the inner side portion into the premix passage.

16. The combustor as in claim 10, further comprising a cap plate that extends radially and circumferentially within the outer casing, the cap plate defining a first side axially separated from a second side and at least one fuel nozzle passage, the outer shroud extending through the fuel nozzle passage, the downstream end portion being positioned axially beyond the second side.

17. A gas turbine, comprising:
a compressor;
a combustor disposed downstream from the compressor;
a turbine disposed downstream from the combustor;
wherein the combustor comprises
an end cover coupled to an outer casing;
a fuel nozzle having a center body that extends axially downstream from the end cover within the outer casing and an outer shroud coaxially aligned with the center body, wherein the outer shroud is radially spaced from the center body to define a pre-mix flow passage therebetween;
wherein the outer shroud includes an annular main body defining an inner side portion, an outer side portion and a forward end portion axially separated from an aft end portion, the aft end portion disposed proximate to a combustion zone defined within the combustor; and
wherein the main body further defines a cooling channel fully circumscribed within the main body, a cooling air inlet in fluid communication with the cooling channel and a cooling air outlet in fluid communication with the cooling channel downstream from the cooling air inlet.

18. The gas turbine as in claim 10, wherein at least a portion of the cooling channel extends within the main body in at least one of a serpentine pattern and a helical pattern.

19. The gas turbine as in claim 10, wherein at least a portion of the cooling channel extends within the main body at least partially around the aft end portion.

20. The combustor as in claim 10, wherein the cooling air inlet:
provides for fluid communication into the cooling channel through at least one of the outer side portion of the main body and a forward end of the main body; and
wherein the aft end portion of the main body terminates at an aft wall, wherein the cooling air outlet provides for fluid communication from the cooling channel through at least one of the aft wall and the inner side portion and the outer side portion.

21. A method for fabricating a main body of an outer shroud portion of a fuel nozzle where the main body defines a cooling channel fully circumscribed within the main body, the method comprising:
determining three-dimensional information of the main body including the cooling channel;
converting the three-dimensional information into a plurality of slices that define a cross-sectional layer of the main body, wherein a void is defined within at least some of the layers defining the cooling channel; and
successively forming each layer of the main body by fusing a metallic powder using laser energy electron beam energy.

22. The method as in claim 21, wherein determining three-dimensional information of the main body further comprises generating a three dimensional model of the main body.

23. The method as in claim 21, wherein determining three-dimensional information of the main body further comprises generating a three dimensional model of the main body including a cooling air inlet that is in fluid communication with the cooling channel and a cooling air outlet that is in fluid communication with the cooling channel downstream from the cooling air inlet.

24. The method as in claim 21, wherein determining three-dimensional information of the main body further comprises generating a three dimensional model of the main body including a cooling air inlet that is in fluid communication with the cooling channel and a cooling air outlet that is in fluid communication with the cooling channel downstream from the cooling air inlet, wherein the cooling air inlet is defined proximate to a forward end portion of the main body and the cooling air outlet is defined along one of an inner surface portion, an outer surface portion or an aft wall portion of the main body.

25. The method as in claim 21, wherein determining three-dimensional information of the main body further comprises generating a three dimensional model of the main body including at least one flow feature that is defined within the main body along the cooling channel.

26. The method as in claim 21, wherein successively forming each layer of the main body by fusing a metallic powder using laser energy further comprises fusing a metallic powder comprising at least one of cobalt chromium, HS188 and INCO 625.

27. The method as in claim 21, wherein successively forming each layer of the main body by fusing a metallic powder using laser energy further comprises fusing a metallic powder that has a particle size between about 10 microns and about 75 microns.

28. The method as in claim 27, wherein successively forming each layer of the main body by fusing a metallic powder using laser energy further comprises fusing a metallic powder that has a particle size between about 15 microns and about 30 microns.

29. A fuel nozzle, comprising:
an outer shroud having an annularly shaped main body and a cooling channel fully circumscribed within the main body; and
wherein the main body is formed by an additive manufacturing process, the additive manufacturing process comprising:
determining three-dimensional information of the main body including the cooling channel;
converting the three-dimensional information into a plurality of slices that define a cross-sectional layer of the main body, wherein a void is defined within at least some of the layers defining the cooling channel; and
successively forming each layer of the main body by fusing a metallic powder using laser energy electron beam energy.

30. The fuel nozzle as in claim 29, wherein the additive manufacturing process is a laser sintering process.

31. The fuel nozzle as in claim 29, wherein the additive manufacturing process is a direct metal laser sintering (DMLS) process.

32. The fuel nozzle as in claim 29, wherein the main body defines a cooling air inlet defined proximate to a forward end portion of the main body and a cooling air outlet defined along one of an inner side portion, an outer side portion or an aft wall of the main body.

33. The fuel nozzle as in claim 32, wherein the cooling air inlet provides for fluid communication into the cooling channel through one of an outer side portion of the main body or a forward wall of the main body.

34. The fuel nozzle as in claim 29, wherein the cooling channel extends within the main body in a substantially helical pattern.

35. The fuel nozzle as in claim 29, wherein the cooling channel extends within the main body in a substantially serpentine pattern.

36. The fuel nozzle as in claim 29, wherein the cooling channel extends within the main body from a forward portion of the main body towards an aft portion of the main body.

37. The fuel nozzle as in claim 29, wherein the main body defines one or more flow features disposed along the cooling channel.
